(19) United States
(12) Patent Application Publication
(10) Pub. No.: US 2023/0409739 A1
(43) Pub. Date: Dec. 21, 2023

(54) INFORMATION PROCESSING DEVICE, MOBILE TERMINAL DEVICE, VEHICLE MANAGEMENT DEVICE, ON-VEHICLE DEVICE, VEHICLE MANAGEMENT SYSTEM, AND PERSONAL INFORMATION PROCESSING METHOD

(71) Applicant: DENSO TEN Limited, Kobe-shi (JP)

(72) Inventors: Yoshikuni MIKI, Kobe (JP); Yuji UNO, Kobe (JP); Masayuki TOYODA, Kobe (JP)

(73) Assignee: DENSO TEN Limited, Kobe-shi (JP)

(21) Appl. No.: 17/987,019

(22) Filed: Nov. 15, 2022

(30) Foreign Application Priority Data
May 17, 2022 (JP) 2022-081002

(51) Int. Cl. G06F 21/62

(52) U.S. Cl. CPC G06F 21/6245

(57) ABSTRACT

An information processing device that executes storage control for personal information data that are stored in a storage unit in an on-vehicle device that executes an operation that is based on personal information data that are stored in the storage unit has a controller. The controller executes a deletion process that deletes personal information data that are stored in the storage unit, in a case where an end of use of a vehicle is detected, and executes a registration process that stores, in the storage unit, personal information data of a user for the on-vehicle device that are acquired from an external device, in a case where a start of use of a vehicle is detected.

### CROSS-REFERENCE TO RELATED APPLICATION(S)

This application is based upon and claims the benefit of priority to Japanese Patent Application No. 2022-081002, filed on May 17, 2022, the entire contents of which are herein incorporated by reference.

### FIELD

A disclosed embodiment(s) relate(s) to an information processing device, a mobile terminal device, a vehicle management device, an on-vehicle device, a vehicle management system, and a personal information processing method.

### BACKGROUND

Conventionally, an automobile is provided with a function that saves, calls when needed, and uses for control, various types of information, for example, for comfort control (see, for example, Japanese Laid-open Patent Publication No. 2001-304896).

Various types of information that are used for such a function, etc., frequently include personal information, so that such personal information is needed to be protected appropriately.

For example, in a case where an automobile is sold, a case where an automobile is temporarily used in a rental service or car sharing, etc., there is a concern that personal information that is left in such an automobile may be leaked to a next user, etc. Furthermore, in a case where an automobile is stolen, there is also a concern that personal information may be leaked.

### SUMMARY

An information processing device according to an aspect of an embodiment is an information processing device that executes storage control for personal information data that are stored in a storage unit in an on-vehicle device that executes an operation that is based on personal information data that are stored in the storage unit, and comprises a controller. The controller executes a deletion process that deletes personal information data that are stored in the storage unit, in a case where an end of use of a vehicle is detected, and executes a registration process that stores, in the storage unit, personal information data of a user for the on-vehicle device that are acquired from an external device, in a case where a start of use of a vehicle is detected.

### BRIEF DESCRIPTION OF DRAWING(S)

FIG. 1 is an explanatory diagram of an outline of a personal information protection method according to an embodiment.

FIG. 2 is a diagram that illustrates a configuration example of a personal information protection system according to an embodiment.

FIG. 3 is a block diagram that illustrates a configuration example of an on-vehicle device according to an embodiment.

FIG. 4 is a diagram that illustrates an example of data that are stored in a personal information data storage unit.

FIG. 5 is a diagram that illustrates an example of personal information control information that is stored in a personal information control information storage unit.

FIG. 6 is a block diagram that illustrates a configuration example of a personal information management server according to an embodiment.

FIG. 7 is a diagram that illustrates an example of a personal information DB.

FIG. 8 is a block diagram that illustrates a configuration example of a user device according to an embodiment.

FIG. 9 is a diagram that illustrates a process sequence for an on-vehicle device and a personal information management server or a user device in a basic deletion process for personal information.

FIG. 10 is a diagram that illustrates a process sequence for an on-vehicle device and a personal information management server or a user device in a basic registration process.

FIG. 11 is a diagram that illustrates an example of an application screen on a user device in a registration process.

FIG. 12 is a diagram that illustrate a process sequence for an on-vehicle device and a rental car management server in a deletion process according to a first variation.

FIG. 13 is a diagram that illustrates a process sequence for an on-vehicle device, a rental car management server, and a service terminal in a deletion process according to a second variation.

FIG. 14 is a diagram that illustrates a process sequence for a user device, an on-vehicle device, and a shared car management server in a deletion process according to a third variation.

FIG. 15 is a diagram that illustrates a process sequence for an on-vehicle device and a shared car management server in a deletion process according to a fourth variation.

FIG. 16 is a diagram that illustrates a process sequence for an on-vehicle device and a vehicle sale and purchase management server in a deletion process according to a fifth variation.

FIG. 17 is a diagram that illustrates a process sequence for an on-vehicle device, a vehicle sale and purchase management server, and a service terminal in a deletion process according to a sixth variation.

FIG. 18 is a block diagram that illustrates a configuration example of a vehicle management device according to an embodiment.

FIG. 19 is a flowchart that illustrates process steps that are executed by an on-vehicle device according to an embodiment.

### DESCRIPTION OF EMBODIMENT(S)

Hereinafter, an embodiment(s) of an information processing device, a mobile terminal device, a vehicle management device, an on-vehicle device, a vehicle management system, and a personal information processing method as disclosed in the present application will be explained in detail with reference to the accompanying drawing(s). Additionally, this invention is not limited by an embodiment(s) as illustrated below.

Furthermore, an automobile will be described as a “vehicle” below. Furthermore, a vehicle that is used in a mode of car sharing will be described as a “shared car” below.

Furthermore, examples of an information processing device according to an embodiment will be provided as an on-vehicle device 10, a user device 30, a personal information management server 100, a rental car management server 300, a shared car management server 500, and a vehicle sale and purchase management server 700 that function for personal information protection, below.

Furthermore, a vehicle management system according to an embodiment will be provided as a personal information protection system 1 that protects personal information of a user in cooperation with respective information processing devices as described above, below. Furthermore, a protective information processing method according to an embodiment will be provided as a personal information protection method that is executed by the personal information protection system 1, below.

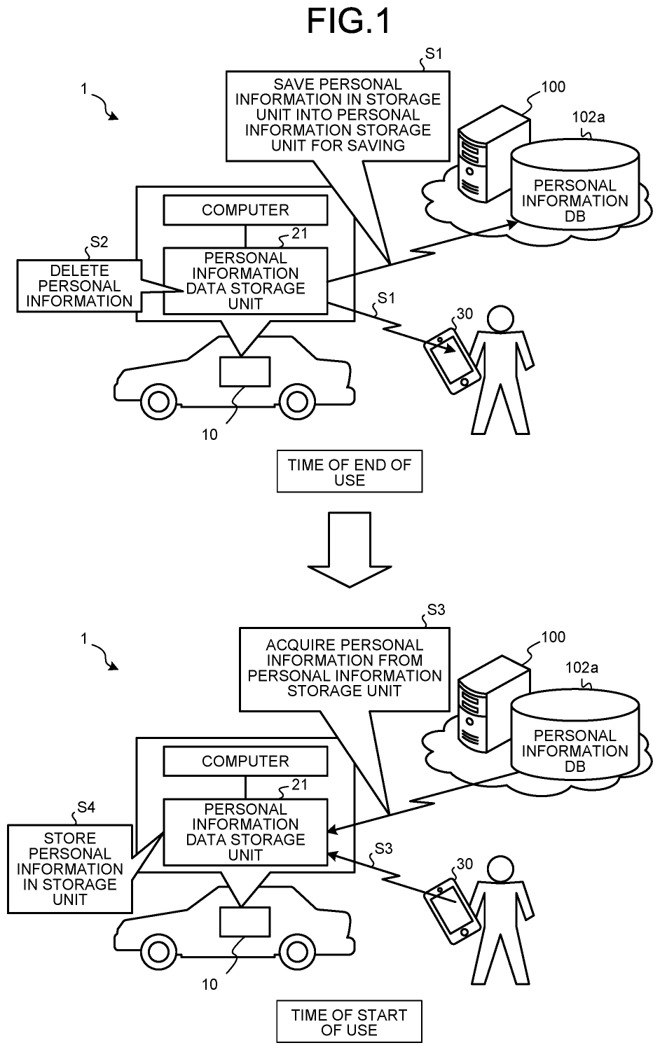

First, an outline of a personal information protection method according to an embodiment will be explained by using FIG. 1. FIG. 1 is an explanatory diagram of an outline of a personal information protection method according to an embodiment.

As illustrated in FIG. 1, a personal information protection system 1 according to an embodiment includes an on-vehicle device 10, a user device 30, and a personal information management server 100.

The on-vehicle device 10 is a device with a built-in computer that is mounted on a vehicle, and is, for example, a dashboard camera, a car navigation device, a multimedia device, a vehicle control device, etc. The on-vehicle device 10 has a personal information data storage unit 21 that stores personal information therein where personal information of a user, etc., is stored and is used for various types of control.

The user device 30 is a terminal device that is utilized by a user that uses a vehicle, and is, for example, a smartphone. The user device 30 corresponds to an example of a mobile terminal device.

The personal information management server 100 is a device that manages personal information data of each user. The personal information management server 100 has a personal information database (DB) 102a. The personal information DB 102a is a database that stores personal information for each of users that use respective vehicles. As illustrated in FIG. 1, in a personal information protection method according to an embodiment, the on-vehicle device 10 saves personal information in the personal information data storage unit 21 into a personal information storage unit for saving at “a time of an end of use” of a vehicle (step S1). The personal information management server 100 or the user device 30 corresponds to an example of a personal information storage unit that is such a destination for saving.

Furthermore, after personal information is saved into a personal information storage unit, the on-vehicle device 10 deletes personal information that is stored in the personal information data storage unit 21 of the on-vehicle device 10 (step S2).

On the other hand, the on-vehicle device 10 acquires (receives) personal information of a corresponding user from a personal information storage unit at “a time of a start of use” of a vehicle (step S3). Then, the on-vehicle device 10 stores acquired personal information in the personal information data storage unit 21 (step S4).

That is, in a personal information protection method according to an embodiment, personal information is not always saved in a side of a vehicle (the personal information data storage unit 21) basically where personal information is automatically deleted at a timing of “a time of an end of use” and personal information of a user is acquired from an external personal information storage unit again at a timing of “a time of a start of use” and is registered on a side of a vehicle (the personal information data storage unit 21).

Additionally, “a time of an end of use” of a vehicle is different depending on various types of usage of a vehicle, a content/a level of personal information protection, etc. For example, in a case where personal information protection is executed when leaving a vehicle, “a time of an end of use” is a timing of a stop of an engine, turning off of a battery (completion of one trip), etc. Furthermore, in a case where personal information protection is executed when an owner of a vehicle is changed, “a time of an end of use” is a timing of a time of completion of a return procedure for a vehicle, etc., for a rental car or a shared car, and “a time of an end of use” is a timing of delivery of a vehicle, etc., at a time of sale (assignment) of a vehicle, etc., for an owner-driven car.

Similarly, “a time of a start of use” of a vehicle is also different depending on various types of usage of a vehicle, a content/a level of personal information protection, etc. In a case where personal information protection is executed when leaving a vehicle, “a time of a start of use” is a timing of a start of an engine, turning on of a battery (a start of one trip), etc.

Furthermore, in a case where personal information protection is executed when an owner of a vehicle is changed, “a time of a start of use” is a timing of an initial start of an engine after borrowing of a vehicle (a start of one trip), etc., for a rental car or a shared car, and “a time of a start of use” is a timing of an initial start of an engine after delivery of a vehicle (a start of one trip), etc., at a time of purchase (receipt) of a vehicle, etc., for an owner-driven car. Additionally, in such cases, latest personal information that is used in a previously utilized vehicle is acquired from an external personal information storage unit again at a timing of “a time of a start of use” and registered in a side of a vehicle (the personal information data storage unit 21).

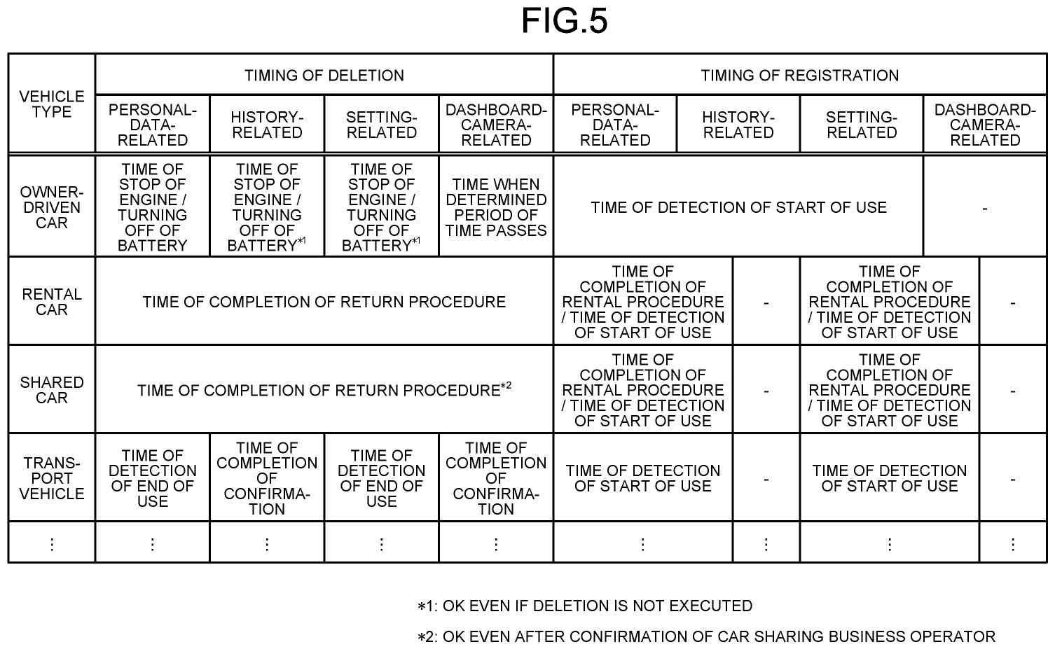

Additionally, a content of control that includes a difference between a timing of deletion and a timing of registration of personal information will be described later in an explanation that uses FIG. 5.

In such a personal information protection method according to an embodiment, it is possible to protect personal information appropriately. Hereinafter, a configuration example of the personal information protection system 1 according to an embodiment will be explained more specifically.

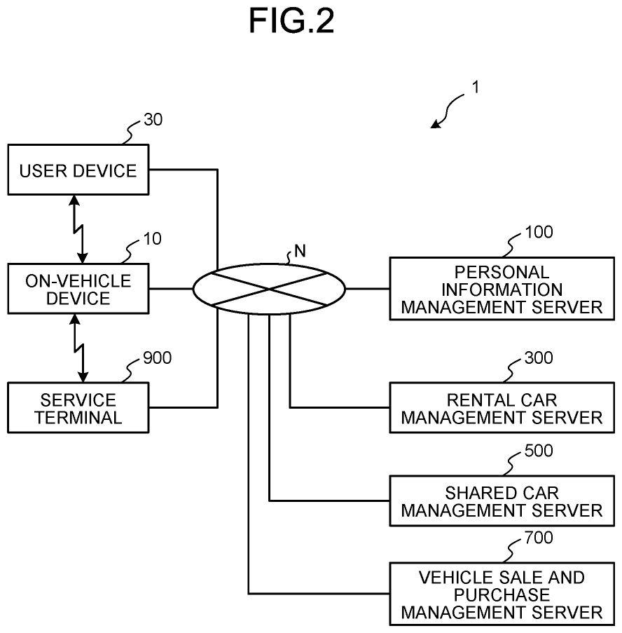

FIG. 2 is a diagram that illustrates a configuration example of a personal information protection system 1 according to an embodiment. The personal information protection system 1 includes a rental car management server 300, a shared car management server 500, a vehicle sale and purchase management server 700, and a service terminal 900, as well as an on-vehicle device 10, a user device 30, and a personal information management server 100.

Each of the rental car management server 300, the shared car management server 500, and the vehicle sale and purchase management server 700 corresponds to an example of a vehicle management device.

The rental car management server 300 is a device that manages an operation of a rental car and is operated by, for example, a car rental business operator. The shared car management server 500 is a device that manages an operation of a shared car and is operated by, for example, a car sharing business operator. The vehicle sale and purchase management server 700 is a device that manages sale and purchase of a vehicle and is operated by, for example, a vehicle sale and purchase business operator.

The service terminal 900 is a terminal for a service such as a maintenance service that is provided by a car rental business operator, a car sharing business operator, and a vehicle sale and purchase business operator.

The on-vehicle device 10, the user device 30, the personal information management server 100, the rental car management server 300, the shared car management server 500, and the vehicle sale and purchase management server 700 are communicably connected to one another through a network N that is composed of the Internet, a mobile phone line network, etc.

Furthermore, it is possible for the on-vehicle device 10 and the user device 30 to execute near field wireless communication by Bluetooth (registered trademark), etc., or direct communication by a Universal Serial Bus (USB) connection communication, etc. It is also possible for the on-vehicle device 10 and the service terminal 900 to execute similar direct communication.

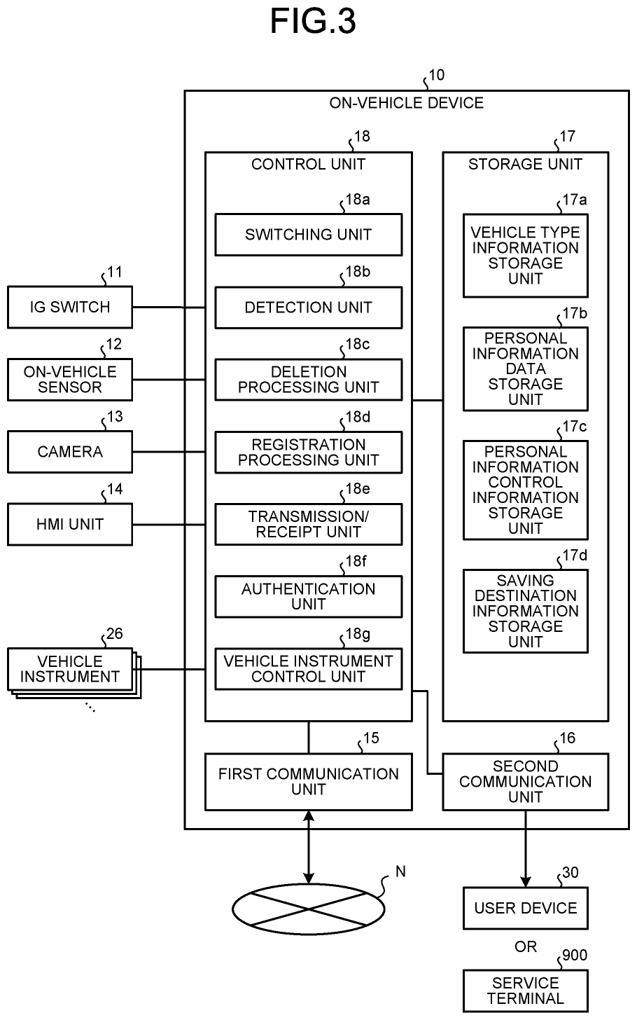

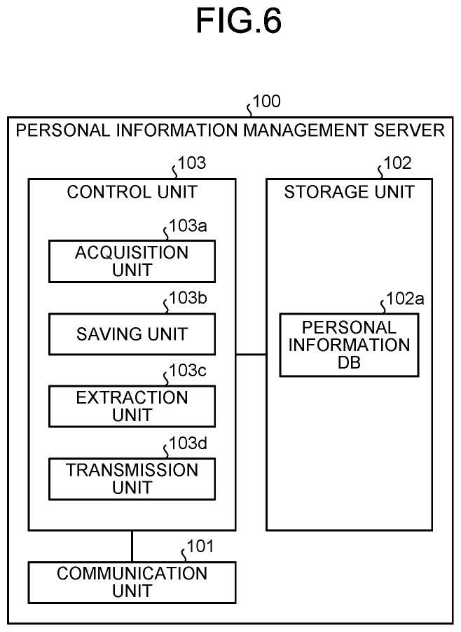

Next, FIG. 3 is a block diagram that illustrates a configuration example of an on-vehicle device 10 according to an embodiment. Additionally, in FIG. 3 and FIGS. 6, 8, and 18 that will be illustrated as block diagrams later, only a component(s) that is/are needed to explain a feature(s) of the present embodiment is/are illustrated and illustration of a general component(s) is omitted.

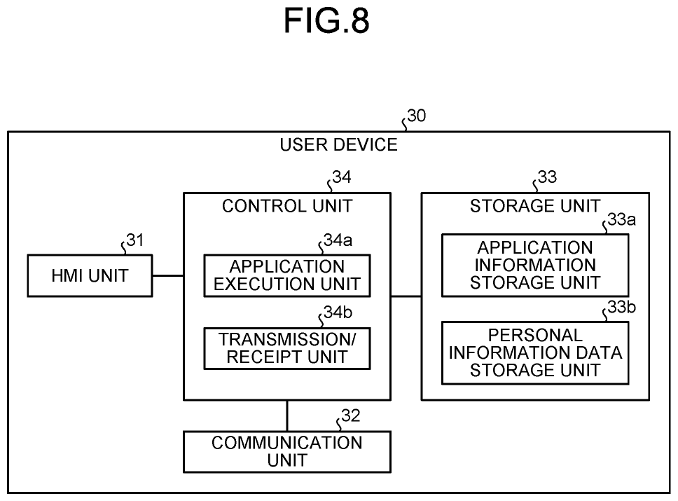

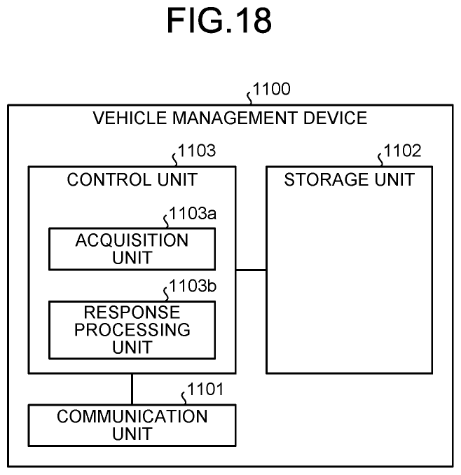

In other words, each component as illustrated in FIG. 3, FIG. 6, FIG. 8, and FIG. 18 is functionally conceptual and does not have to be physically configured as illustrated therein. For example, a specific mode of distribution/integration of respective blocks is not limited to an illustrated one, so that it is possible to distribute/integrate all or a part thereof functionally or physically in any unit, depending on various types of loads, usage, etc., so as to provide a configuration.

Furthermore, in an explanation(s) that use(s) FIG. 3, FIG. 6, FIG. 8, and FIG. 18, for a component that has already been explained, an explanation thereof may be simplified or such an explanation thereof may be omitted.

As illustrated in FIG. 3, the on-vehicle device 10 according to an embodiment is connected to an Ignition (IG) switch 11, an on-vehicle sensor 12, a camera 13, and a Human Machine Interface (HMI) unit 14 that are appropriately installed in a vehicle. Then, the on-vehicle device 10 has a first communication unit 15, a second communication unit 16, a storage unit 17, and a control unit 18. Furthermore, the on-vehicle device 10 is connected to various types of vehicle instruments 26 and the on-vehicle device 10 controls such vehicle instruments 26 or executes data communication with the vehicle instruments 26.

The IG switch 11 is a switch for control (battery supply/shutdown) of a battery system of a vehicle and for a start/a stop of an engine. The on-vehicle sensor 12 is various types of sensors that are mounted on a vehicle. The camera 13 is attached to various positions of a vehicle such as a front window, a rear window, a side mirror(s), and/or a dashboard, and captures an image(s) of an inside and/or an outside of such a vehicle.

The HMI unit 14 is a component that provides an interface component concerning an input from and an output to a user. The HMI unit 14 includes an input interface that receives an input operation from a user. An input interface is realized by, for example, a touch panel. Additionally, an input interface may be realized by, a keyboard, a mouse, a pen-based tablet, a microphone, etc. Furthermore, an input interface may be realized by a software component.

Furthermore, the HMI unit 14 includes an output interface that presents image information and/or sound information to a user. An output interface is realized by, for example, a display, a speaker, etc.

The first communication unit 15 is realized by a network adapter, etc. The first communication unit 15 is wirelessly connected to a network N and executes transmission/receipt of information to/from another/other device(s) that is/are included in the personal information protection system 1 through the network N.

The second communication unit 16 is realized by a network adapter, etc. The second communication unit 16 executes near field wireless communication or wire communication with a user device 30 or a service terminal 900 and executes transmission/receipt of information to/from the user device 30 or the service terminal 900.

The storage unit 17 is realized by a storage device such as a Random Access Memory (RAM) and/or a flash memory (Flash Memory). In an example of FIG. 3, the storage unit 17 has a vehicle type information storage unit 17a, a personal information data storage unit 17b, a personal information control information storage unit 17c, and a saving destination information storage unit 17d in a storage area thereof.

The vehicle type information storage unit 17a stores vehicle type information concerning a type of a vehicle that depends on a difference of a type of usage thereof. In a case where a vehicle that mounts the on-vehicle device 10 thereon is an owner-driven car, vehicle type information that indicates that it is an owner-driven car is registered in the vehicle type information storage unit 17a. Similarly, in a case where a vehicle is a rental car or a shared car, vehicle type information that indicates that it is a rental car or a shared car is registered in the vehicle type information storage unit 17a. In addition, in a case where a vehicle is a transport vehicle such as a taxi, vehicle type information that indicates that it is a transport vehicle is registered in the vehicle type information storage unit 17a.

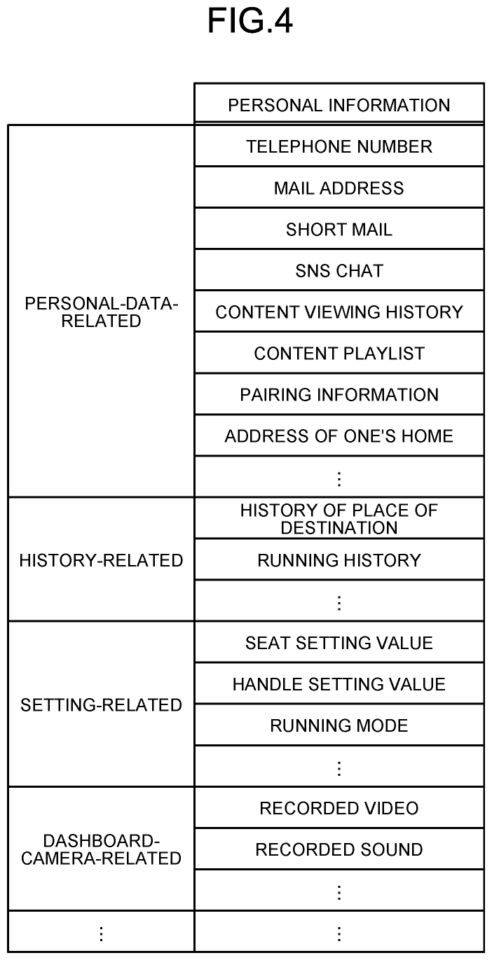

The personal information data storage unit 17b corresponds to a personal information data storage unit 21 as illustrated in FIG. 1. The personal information data storage unit 17b stores data of a personal information group that is a collection of personal information of a user. FIG. 4 is a diagram that illustrates an example of data that are stored in a personal information data storage unit 17b. As illustrated in FIG. 4, for personal information that is stored in the personal information data storage unit 17b, it is possible to provide, for example, a telephone number, a mail address, a short mail, a Social Network Service (SNS) chat, a content viewing history, a content playlist, pairing information (information concerning a connection destination instrument for communication such as Bluetooth (registered trademark)), an address of one's home, etc., as a data content(s) concerning a person himself/herself, a possession and/or an action of such a person, etc.

Furthermore, for a history-related one concerning use (movement) of a vehicle, it is possible to provide, a history of a place of destination, a running history, etc. Furthermore, for setting-related one of a vehicle, it is possible to provide a seat setting value, a handle setting value, a running mode, etc. Furthermore, for a dashboard-camera-related one, it is possible to provide a recorded video, a recorded sound, etc. Each of data of such personal information as illustrated in FIG. 4 is stored in the personal information data storage unit 17b.

An explanation for FIG. 3 is returned to. The personal information control information storage unit 17c stores personal information control information that is a control content and/or a control target condition concerning control of deletion and registration of personal information that depends on vehicle type information. Herein, such a control content will be explained by using FIG. 5.

FIG. 5 is a diagram that illustrates an example of personal information control information that is stored in a personal information control information storage unit 17c. Personal information control information is configured as a data table that stores a control content concerning deletion and registration of various types of information for each type of a vehicle. In the personal information control information storage unit 17c, a personal information control data table as illustrated in FIG. 5 is configured in such a manner that control data that correspond to each control content are stored in such a data table.

Specifically, personal information control information is configured in such a manner that a “vehicle type” is a so-called primary key and data that indicate a condition of a timing of deletion and a timing of registration of each category of personal information (“personal-data-related (deletion timing condition)”, “history-related (deletion timing condition)”, “setting-related (deletion timing condition)”, “dashboard-camera-related (deletion timing condition)”, “personal-data-related (registration timing condition)”, “history-related (registration timing condition)”, “setting-related (registration timing condition)”, and “dashboard-camera-related (registration timing condition)”) are stored in each data item section in a data record with a “vehicle type” that is provided as an identification key.

Specifically, in an example of a data table in FIG. 5, in each of data records of an owner-driven car, a rental car, a shared car, and a transport vehicle for a “vehicle type”, respective data of “personal-data-related (deletion timing condition)”, “history-related (deletion timing condition)”, “setting-related (deletion timing condition)”, “dashboard-camera-related (deletion timing condition)”, “personal-data-related (registration timing condition)”, “history-related (registration timing condition)”, “setting-related (registration timing condition)”, and “dashboard-camera-related (registration timing condition)” that correspond to such a vehicle type are stored.

Then, for data in such a data table, appropriate data that are obtained from development/setting, etc., that is/are executed by a vehicle manufacturer, etc., are preliminarily registered. Furthermore, it is possible to update data in such a data table by a manual operation of a vehicle owner, etc., so that it is possible for a vehicle owner, etc., to execute appropriate setting depending on a type of usage of a vehicle, etc. Additionally, it is preferable that default data for a data table are stored separately and it is possible to update data in such a data table by stored default data (to return to default data) according to an instruction for registration of default data that is provided by a manual operation of a vehicle owner, etc.

Additionally, “personal-data-related”, “history-related”, “setting-related”, and “dashboard-camera-related” in sections of a timing of deletion and a timing of registration in FIG. 5 correspond to respective categories of personal information as illustrated in FIG. 4.

Next, a specific example of a content of data in personal information control information will be explained. In a case where a vehicle type is an owner-driven car, a timing of deletion of “personal-data-related” personal information is a time of a stop of an engine or a turning off of a battery as illustrated in FIG. 5. Furthermore, a timing of deletion of “history-related” and “setting-related” personal information is also a time of a stop of an engine or turning off of a battery. Such information is information that is used during use of a vehicle and further a data volume thereof is so low that saving of information into a user device 30, etc., is readily executed (is actually possible), so that a timing of deletion of personal information is a time of a stop of an engine or a turning off of a battery. Additionally, a characteristic of “history-related” and “setting-related” personal information is slightly low (so as not to identify a person and a characteristic directly) and a degree of demand of a secret is slightly low, so that deletion of “history-related” and “setting-related” personal information at a time of a stop of an engine or turning off of a battery may be executed at a timing of a deletion operation that is executed manually, as indicated by *1, on another condition, for example, at a timing of sale of a vehicle or in a case where a vehicle is not utilized for a long period of time.

Furthermore, a timing of deletion of “dashboard-camera-related” personal information is a time when a period of time that is determined depending on an importance of information that is recorded in a dashboard camera passes. That is, dashboard-camera-related information is frequently utilized after an end of driving of a vehicle, for confirmation of a driving situation and/or an accident, etc., and is needed to be left for a while even after such an end of driving of a vehicle, so that a timing as described above is preferable as a timing of deletion. Then, for example, in a case where rapid acceleration (where a chance of occurrence of collision, etc., is high) is executed, a case where an operation of video recording protection is executed by a user, a case where information that an accident, etc., occur(s) on a running route in a running time of a day is obtained, etc., a record of “dashboard-camera-related” personal information is held for a comparatively long period of time even after an end of driving of a vehicle.

Furthermore, in a case where a vehicle type is an owner-driven car, a timing of registration of “personal-data-related”, “history-related”, and “setting-related” personal information is a time of detection of a start of use. That is, in a case where an owner-driven car is provided, such personal information is information that is used at a time of use of a vehicle, so that registration of latest personal information at a time of detection of a start of use is preferable. Additionally, a time of detection of a start of use is turning on of a battery or a start of an engine, a case where approaching of a user is detected through near field wireless communication with the user device 30, etc. “dashboard-camera-related” one is information that is transmitted from a dashboard camera during an operation of such a dashboard camera, so as not to be a registration target for registration timing information.

Additionally, in a case where acquisition of such personal information is not executed at a timing as described above, for example, a case where it is not possible to acquire personal information from the user device 30, etc., at a time of turning on of a battery or a start of an engine, new registration of each personal information in the personal information control information storage unit 17c is not executed, and a state where registered personal information is stored or a state where personal information is not stored (a case where registered personal information is not recorded) is provided.

Next, a specific example of a content of data in personal information control information in a case where a vehicle type is a rental car will be explained. In a case where a vehicle type is a rental car, it is preferable that a timing of deletion of personal information is a time of completion of a return procedure, regardless of a category. That is, in a case of a rental car, a vehicle is possessed and used by a borrower for only a rental period, so that personal information is used for such a rental period. Furthermore, as an aspect of vehicle management of a rental car is taken into consideration, for “personal-data-related” personal information that specifies a vehicle borrower and/or “history-related” and “dashboard-camera-related” personal information that are information concerning damage, an accident, etc., of a vehicle, a record thereof is needed to be maintained until such a vehicle is returned. Therefore, in a case of a rental car, storage of personal information concerning a borrower is maintained during only such a rental period.

Additionally, “dashboard-camera-related” one may be requested to provide a captured image, etc., (as, for example, an investigation material for a case/an accident that occur(s) at a periphery) by a public agency, etc., such as police, so that a method that deletes data at a point of time when a period of time for maintenance of a record after a rental period passes by a predetermined period of time is also effective. Additionally, personal information of a user that is a rental car user is saved into the personal information management server 100 or the user device 30 before deletion of such personal information.

Furthermore, in a case where a vehicle type is a rental car, it is preferable that a timing of registration of “personal data” and “setting-related” personal information is a time of completion of a rental procedure or a time of first detection of a start of use after completion of such a rental procedure, because such personal information is used for such a rental period. Additionally, a time of detection of a start of use is turning on of a battery or a start of an engine, a case where approaching of a user is detected through near field wireless communication with the user device 30, etc. Furthermore, “history-related” and “dashboard-camera-related” one is information that is transmitted from a navigation device and/or a dashboard camera after a start of running of a vehicle, so as not to be a registration target for registration timing information.

Next, a specific example of a content of data in personal information control information in a case where a vehicle type is a shared car will be explained. In a case where a vehicle type is a shared car, it is preferable that a timing of deletion of personal information is a time of completion of a return procedure, regardless of a category. That is, in a case of a shared car, a vehicle is possessed and used by a borrower for only a rental period, so that personal information is used for such a rental period. Furthermore, in a case of car sharing, a procedure from a rental to a return without a business operator is possible, so that, as an aspect of vehicle management of a shared car is taken into consideration, for “personal-data-related” personal information that specifies a borrower for a vehicle, and/or “history-related” and “dashboard-camera-related” personal information that are information concerning damage and/or an accident, etc., of a vehicle, a record thereof is needed to be maintained until a car sharing business operator confirms a state of a vehicle after a return thereof, as indicated by *2. Therefore, in a case of a shared car, storage of personal information concerning a borrower is maintained for only a rental period of a vehicle for a car sharing business operator (from a start of rental to confirmation of a vehicle state after a return).

Additionally, “dashboard-camera-related” one may be requested to provide a captured image, etc., (as, for example, an investigation material for a case/an accident that occur(s) at a periphery) by a public agency, etc., such as police, so that a method that deletes data at a point of time when a period of time for maintenance of a record after a rental period passes by a predetermined period of time is also effective.

Furthermore, personal information of a user that is a shared car user is saved into the personal information management server 100 or the user device 30 before deletion of such personal information. Furthermore, in a case where a vehicle type is a shared car, for registration target information and a registration timing, it is preferable that “personal-data-related” and “setting-related” personal information are registered at a time of completion of a rental procedure or a time of first detection of a start of use after completion of such a rental procedure, similarly to a case of a rental car.

Next, a specific example of a content of data in personal information control information in a case where a vehicle type is a transport vehicle will be explained. In a case where a vehicle type is a transport vehicle, it is preferable that a timing of deletion of “personal-data-related” and “setting-related” personal information is a time of a stop of an engine or turning off of a battery.

Furthermore, it is preferable that a timing of deletion of “history-related” and “dashboard-camera-related” personal information is a time of completion of confirmation of such information that is executed by a manager of a transport business operator that possesses such a vehicle or manages a driver. That is, in a case of a transport vehicle, such personal information is important for, for example, confirmation of execution of safe driving and/or confirmation of a driving situation of a driver (driving management) for confirmation of running on an appropriate driving route.

Additionally, “dashboard-camera-related” one may be requested to provide a captured image, etc., by a public agency, etc., such as police, so that a method that deletes data at a point of time when a predetermined period of time passes after completion of confirmation of such information that is executed by a manager of a transport business operator is also effective.

Furthermore, in a case where a vehicle type is a transport vehicle, it is preferable that a timing of registration of “personal-data-related” and “setting-related” personal information is a time of detection of a start of use of a vehicle. That is, in a case of a transport vehicle, a driver is frequently changed for each use of a vehicle (in particular, in a case of a transport business operator that has a lot of vehicles and/or drivers (employees)), so that it is preferable that “personal-data-related” and “setting-related” personal information are registered at a time of detection of a start of use of a vehicle. Additionally, a time of detection of a start of use is turning on of a battery or a start of an engine, a case where approaching of a user is detected through near field wireless communication with the user device 30, etc. Furthermore, “history-related” and “dashboard-camera-related” personal information are information that is transmitted from a dashboard camera during an operation of such a dashboard camera, so as not to be a registration target for registration timing information.

An explanation for FIG. 3 is returned to. The saving destination information storage unit 17d includes information concerning a device that corresponds to a personal information storage unit that is a destination for saving where the information is provided for connecting to a network address, etc., of such a device (for example, the personal information management server 100 or the user device 30).

The control unit 18 is a controller and is realized by a Central Processing Unit (CPU), a Micro Processing Unit (MPU), etc., where various types of programs that are stored in the storage unit 17 are executed while a RAM is provided as a working area. Furthermore, it is possible to realize the control unit 18 by an integrated circuit such as an Application Specific Integrated Circuit (ASIC) and/or a Field Programmable Gate Array (FPGA).

The control unit 18 has a switching unit 18a, a detection unit 18b, a deletion processing unit 18c, a registration processing unit 18d, a transmission/receipt unit 18e, an authentication unit 18f, and a vehicle instrument control unit 18g, and realizes or executes a function and/or an action of information processing as explained below.

The switching unit 18a selects a corresponding data record of personal information control information that is stored in the personal information control information storage unit 17c depending on vehicle type information that is stored in the vehicle type information storage unit 17a and sets each of control data in such a data record as control data that are used for processing, so as to switch between an operation mode of the deletion processing unit 18c and an operation mode of the registration processing unit 18d.

The detection unit 18b detects a time of an end of use or a time of a start of use of a vehicle based on an input(s) from the IG switch 11, the on-vehicle sensor 12, the camera 13, the first communication unit 15, and/or the second communication unit 16. That is, the detection unit 18b determines whether or not a deletion condition(s) and a registration condition(s) of various types of personal information that are set based on personal information control information are satisfied, based on an input(s) from the IG switch 11, the on-vehicle sensor 12, etc., as described above, and detects a timing(s) of deletion or a timing(s) of registration of various types of personal information.

The deletion processing unit 18c executes, in a case where a timing(s) of deletion of various types of personal information is/are detected by the detection unit 18b, a deletion process as illustrated at steps S1, S2 in FIG. 1 for corresponding various types of personal information. The registration processing unit 18d executes, in a case where a timing(s) of registration of various types of personal information is/are detected by the detection unit 18b, a registration process as illustrated at steps S3, S4 in FIG. 1.

The transmission/receipt unit 18e executes a transmission/receipt process for data to/from the personal information management server 100 or the user device 30, etc., that is executed in a deletion process and a registration process. The authentication unit 18f acquires, in a case where a vehicle type is a shared car, authentication information of a user from the user device that is read by the second communication unit 16, and executes an authentication process where such a user is authenticated as a legitimate user for a vehicle, based on such authentication information.

The vehicle instrument control unit 18g controls the vehicle instruments 26 that are mounted on a vehicle and realize various types of functions concerning such a vehicle, or executes data communication (communicates information) with the vehicle instruments 26. That is, the vehicle instrument control unit 18g controls the vehicle instruments 26 based on personal information data that are stored in the storage unit 17 (the personal information data storage unit 17b). Furthermore, the vehicle instrument control unit 18g extracts personal information data that are used for control by the vehicle instruments 26 from the storage unit 17 (the personal information data storage unit 17b) and provides them to the vehicle instruments 26. Furthermore, the vehicle instrument control unit 18g acquires adjustment values of the vehicle instruments 26 (control values, etc., that are adjusted by a user operation) and registers or updates them as personal information data that are stored in the storage unit 17 (the personal information data storage unit 17b). The vehicle instrument control unit 18g executes such various types of control and/or processing.

Next, a configuration example of the personal information management server 100 will be explained. FIG. 6 is a block diagram that illustrates a configuration example of a personal information management server 100 according to an embodiment. As illustrated in FIG. 6, the personal information management server 100 according to an embodiment has a communication unit 101, a storage unit 102, and a control unit 103.

The communication unit 101 is realized by a network adapter, etc. The communication unit 101 is connected to a network N by wire or wirelessly and executes transmission/receipt of information to/from an on-vehicle device 10 through the network N.

The storage unit 102 is realized by a storage device such as a RAM, a flash memory, a hard disk, and/or an optical disk. Furthermore, a personal information DB 102a is formed in the storage unit 102. As described above, the personal information DB 102a is a database that stores personal information data for each user that uses respective vehicles.

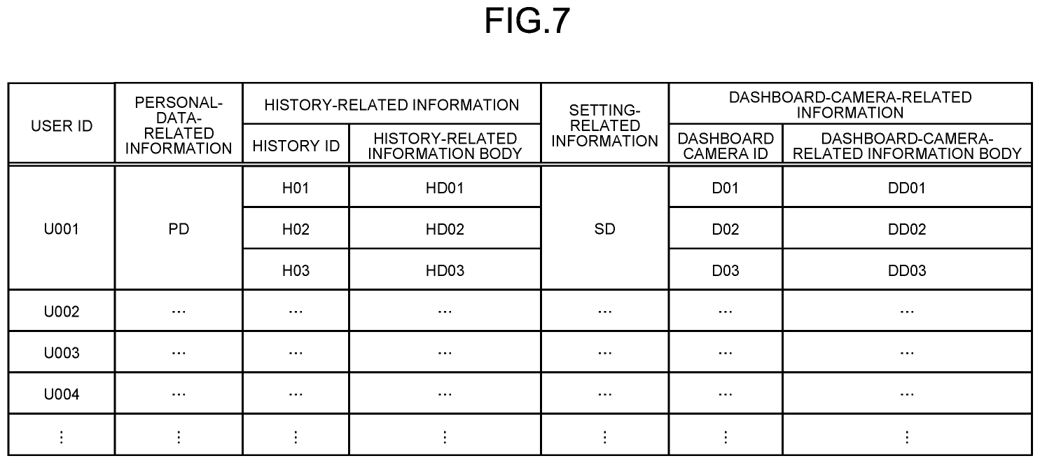

FIG. 7 is a diagram that illustrates an example of a personal information DB 102a. As illustrated in FIG. 7, a “user ID” is a code that identifies a user and has a function of a main code of personal information data. That is, a data record that is identified by a user ID for each user ID is generated and various types of personal information data are stored in such a data record.

“personal-data-related information” stores data for each data item in personal-data-related information as illustrated in FIG. 4. Additionally, although FIG. 7 displays respective data items in “personal-data-related information” so as to be collected (in one frame), data for respective data items are stored so as to be capable of being separated/identified. Furthermore, data of “personal-data-related information” are updated by an update operation for personal-data-related information that is executed by a user (for example, a change operation for a mail address, etc.).

“setting-related information” stores data for each data item in setting-related information as illustrated in FIG. 4. Additionally, although FIG. 7 displays respective data items in “setting-related information” so as to be collected (in one frame), data for respective data items are stored so as to be capable of being separated/identified. Furthermore, data of “setting-related information” are updated by setting information (for example, seat position information after changing when a seat position is changed, etc.) that is changed in association with a change operation for setting that is executed by a user.

“history-related information” stores data for each data item in history-related information as illustrated in FIG. 4. For “history-related information”, information is generated for each trip, so that a small data record where a stored piece of history-related information in a data record that is identified by a user ID is subdivided is provided and history-related information for each trip is stored in such a small data record. Additionally, it is also possible to provide “history-related information” as another data base that is linked by a “user ID”. Specifically, a small data record is generated for each trip and a history code that identifies a history is stored in a “history ID”. A “history ID” also executes a function of a main code of a small data record. Then, each of history-related information data concerning such a trip is stored in a “history-related information body”. Additionally, although FIG. 7 displays respective data items in a “history-related information body” so as to be collected (in one frame), data for respective data items are stored so as to be capable of being separated/identified. Furthermore, “history-related information” is accumulated, so that it is desirable to delete it appropriately, such as to delete it after a predetermined period of time passes after recording, or to delete it when a similar history (such as a place of departure and a place of destination that are identical thereto) is generated.

“dashboard-camera-related information” stores data for each data item in dashboard-camera-related information as illustrated in FIG. 4. Also for “dashboard-camera-related information”, information is generated for each trip, so that a small data record where a stored piece of dashboard-camera-related information in a data record that is identified by a user ID is subdivided is provided and dashboard-camera-related information for each trip is stored in such a small data record. Additionally, it is also possible to provide “dashboard-camera-related information” as another database that is linked by a “user ID”. Specifically, a small data record is generated for each trip and a dashboard camera code that identifies dashboard-camera-related information (what trip data are provided for) is stored in “dashboard camera ID”. “dashboard camera ID” also executes a function of a main code of a small data record. Then, each of data of dashboard-camera-related information concerning such a trip is stored in “dashboard-camera-related information body”. Additionally, although FIG. 7 displays respective data items in “dashboard-camera-related information body” so as to be collected (in one frame), data for respective data items are stored so as to be capable of being separated/identified. Furthermore, “dashboard-camera-related information” is accumulated, so that it is desirable to delete it appropriately, such as to delete it after a predetermined period of time passes after recording or to delete it when a similar history (a place of departure and a place of destination are identical thereto, etc.) is generated.

An explanation for FIG. 6 is returned to. The control unit 103 is a controller that is similar to the control unit 18 as described above and is realized by a CPU, an MPU, etc., where various types of programs that are stored in the storage unit 102 are executed while a RAM is provided as a working area. Furthermore, it is possible to realize the control unit 103 by an integrated circuit such as an ASIC and/or an FPGA.

The control unit 103 has an acquisition unit 103a, a saving unit 103b, an extraction unit 103c, and a transmission unit 103d, and realizes or executes a function and/or an action of information processing as explained below.

The acquisition unit 103a acquires personal information data that are a request for saving and/or a saving target from the on-vehicle device 10, and/or a request for registration from the on-vehicle device 10, through the communication unit 101. The saving unit 103b saves (updates and/or accumulates depending on an information type), in a case where the acquisition unit 103a acquires personal information data that are a request for saving and a saving target from the on-vehicle device 10, corresponding personal information data into the personal information DB 102a.

The extraction unit 103c extracts, in a case where the acquisition unit 103a acquires a request for registration from the on-vehicle device 10, personal information data that are a registration target for the on-vehicle device 10 from the personal information DB 102a, based on such a request for registration.

The transmission unit 103d transmits personal information data that are extracted by the extraction unit 103c to a corresponding on-vehicle device 10 through the communication unit 101. Furthermore, the transmission unit 103d transmits various types of response information for a request for saving or a request for registration of personal information data to a corresponding on-vehicle device 10.

Next, FIG. 8 is a block diagram that illustrates a configuration example of a user device 30 according to an embodiment. As illustrated in FIG. 8, the user device 30 has an HMI unit 31, a communication unit 32, a storage unit 33, and a control unit 34.

The HMI unit 31 is a component that provides an interface component concerning an input from and an output to a user, and has a configuration that is similar to that of the HMI unit 14 as described above so that an explanation thereof will be omitted herein. Additionally, a shape, a size, a performance, etc., of the HMI unit 31 are dependent on a shape, a size, and a requested performance of the user device 30.

The communication unit 32 is realized by a network adapter, etc. The communication unit 32 is wirelessly connected to a network N and executes transmission/receipt of information to/from an on-vehicle device 10 through the network N. Furthermore, the communication unit 32 is connected to the on-vehicle device 10 by near field wireless communication and executes transmission/receipt of information to/from the on-vehicle device 10.

The storage unit 33 is realized by a storage device such as a RAM and/or a flash memory and is used for storage of various types of data, storage (development) of a program in association with execution of such a program, temporary storage of data that are generated during processing, etc. Furthermore, the storage unit 33 is provided with an application information storage unit 33a and a personal information data storage unit 33b that store application information and personal information data respectively. Application information includes a program of a dedicated application for a personal information protection system 1 that is executed by the control unit 34, etc. The personal information data storage unit 33b saves and stores, in a case where a request for saving is received from the on-vehicle device 10, personal information data that are transmitted from the on-vehicle device 10. Additionally, the personal information data storage unit 33b is provided with, for example, a configuration that uses a rewritable non-volatile memory such as a flash memory, and/or a configuration where a backup battery is added thereto, so as to hold data even when a battery of the user device 30 is turned off, etc.

The control unit 34 is a controller that is similar to the control unit 18 and the control unit 103 as described above, is composed of a CPU, a MPU, etc., and is realized by such a CPU, a MPU, etc., that execute(s) various types of programs that are stored in the storage unit 33 while a RAM is provided as a working area. Furthermore, it is possible to realize the control unit 34 by an integrated circuit such as an ASIC or an FPGA.

The control unit 34 has an application execution unit 34a and a transmission/receipt unit 34b, and realizes a function and/or an action of information processing as explained below.

The application execution unit 34a reads and executes a program of an aforementioned dedicated application from the application information storage unit 33a so as to realize various types of functions of such an application. Specifically, the application execution unit 34a executes various types of processing that are based on an operation data input that is executed by an operation of a user through the HMI unit 31 and such an operation data, and an output of various types of information through the HMI unit 31, video information, and/or sound information.

Furthermore, the application execution unit 34a executes transmission/receipt of information to/from the on-vehicle device 10 in execution of an application, through the transmission/receipt unit 34b. Specifically, the application execution unit 34a saves and stores, in a case where a request for saving is received from the on-vehicle device 10, personal information data that are transmitted from the on-vehicle device 10 into/in the personal information data storage unit 33b. Furthermore, the application execution unit 34a extracts, in a case where a request for registration is received from the on-vehicle device 10, corresponding personal information data from the personal information data storage unit 33b, and transmits extracted personal information data to the on-vehicle device 10 through the transmission/receipt unit 34b.

Additionally, the control unit 34 determines whether personal information data where a request for saving thereof is provided from the on-vehicle device 10 are personal information of an owner of such a user device 30 (a mobile terminal device), and executes a saving storage process as described above in a case where it is personal information of an owner of the user device 30 (a mobile terminal device). Specifically, while personal information data that are transmitted/received between the on-vehicle device 10 and the user device 30 include data that are capable of identifying the user device 30 (identification data for the user device 30, a personal code of an owner, etc.) and further the user device 30 stores such data for identification (identification data for the user device 30, a personal code of an owner, etc.), the control unit 34 checks such transmitted/received data for identification and data for identification that are stored in the user device 30. Then, the control unit 34 determines whether personal information data where a request for saving thereof is provided from the on-vehicle device 10 are personal information of an owner of such a user device 30 (a mobile terminal device) based on a result of such a check.

The transmission/receipt unit 34b executes transmission/receipt of information to/from the on-vehicle device 10 in execution of an application through the communication unit 32 based on an instruction of the application execution unit 34a.

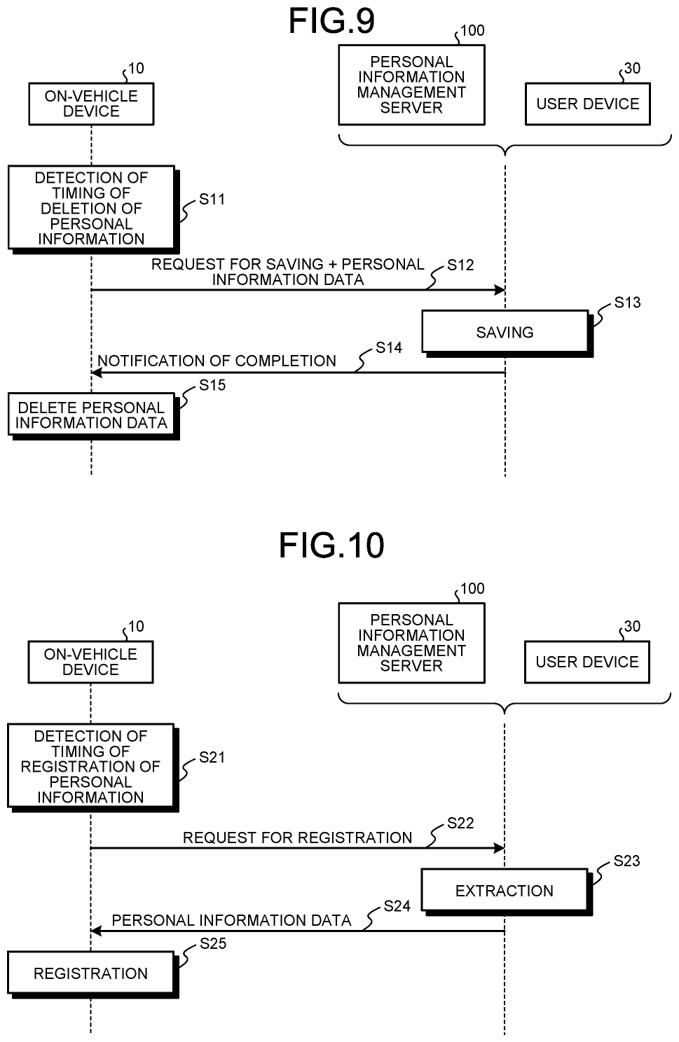

Next, a process sequence for the on-vehicle device 10 and the personal information management server 100 or the user device 30 in a basic deletion process for personal information will be explained. FIG. 9 is a diagram that illustrates a process sequence for an on-vehicle device 10 and a personal information management server 100 or a user device 30 in a basic deletion process for personal information.

As illustrated in FIG. 9, as the on-vehicle device 10 (a control unit 18) detects a timing of deletion of personal information based on personal information control information that is stored in a personal information control information storage unit 17c and corresponds to a type of a his/her own vehicle (step S11), it transmits a request for saving and personal information data that are an saving target to the personal information management server 100 or the user device 30 based on such personal information control information (step S12).

Then, the personal information management server 100 (a control unit 103) or the user device 30 (a control unit 34) that receives a request for saving that is transmitted from the on-vehicle device 10 saves personal information data as a saving target that are transmitted from the on-vehicle device 10 in a personal information DB 102a or a personal information data storage unit 33b (step S13).

Additionally, in a case of a request for saving of personal information to the personal information management server 100, personal information data that are transmitted from the on-vehicle device 10 include user ID data that identify a user and personal information data from the on-vehicle device 10 are stored in a data record of such user ID data in the personal information DB 102a. Furthermore, in a case of a request for saving of personal information to the user device 30, such personal information data are transmitted from the on-vehicle device to the user device 30 of a user that is a target of such personal information data and such personal information data are stored in the personal information data storage unit 33b of the user device 30.

Then, the personal information management server 100 or the user device 30 transmits, to the on-vehicle device 10, notification of completion that indicates that saving of personal information data is completed (step S14).

Then, as the on-vehicle device 10 receives such notification of completion, it deletes personal information data that are stored in a personal information data storage unit 17b of the on-vehicle device 10 (step S15).

Next, a process sequence for the on-vehicle device 10 and the personal information management server 100 or the user device 30 in a basic registration process for personal information will be explained. FIG. 10 is a diagram that illustrates a process sequence for an on-vehicle device 10 and a personal information management server 100 or a user device 30 in a basic registration process for personal information.

As illustrated in FIG. 10, as the on-vehicle device 10 (a control unit 18) detects a timing of registration of personal information based on personal information control information that is stored in a personal information control information storage unit 17c and corresponds to a type of a his/her own vehicle (step S21), it transmits a request for registration to the personal information management server 100 or the user device 30 (step S22).

Then, the personal information management server 100 (a control unit 103) or the user device 30 (a control unit 34) that receives a request for registration that is transmitted from the on-vehicle device 10 extracts personal information data that are a target of a request for registration that is transmitted from the on-vehicle device from a personal information DB 102a or a personal information data storage unit 33b (step S23).

Additionally, in a case of a request for registration of personal information to the personal information management server 100, a request for registration that is transmitted from the on-vehicle device includes user ID data that identify a target user of personal information and personal information data from a data record of such user ID data in the personal information DB 102a are extracted. Furthermore, in a case of a request for registration of personal information to the user device 30, such a request for registration is transmitted from the on-vehicle device 10 to the user device 30 of a user that is a target of such personal information data and personal information data that are stored in the personal information data storage unit 33b of such a user device 30 are extracted.

Then, the personal information management server 100 or the user device 30 transmits extracted personal information data to the on-vehicle device 10 (step S24).

Then, as the on-vehicle device 10 receives such personal information data, it registers such personal information data in a personal information data storage unit 17b (step S25).

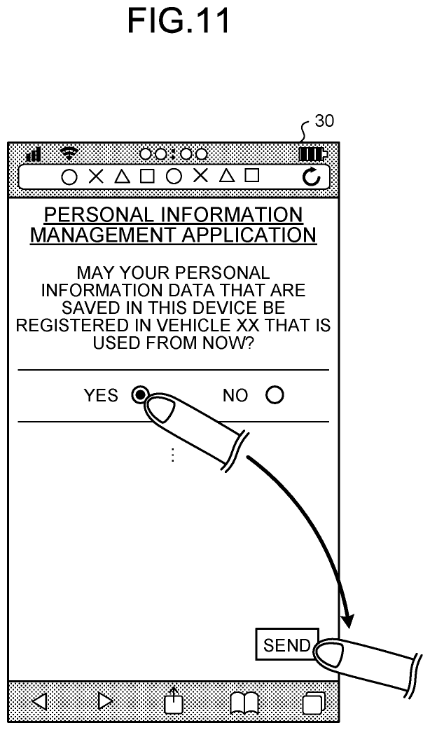

FIG. 11 is a diagram that illustrates an example of an application screen of a user device 30 in a registration process. Such an application is activated by a user before use of a vehicle in a case where utilization, update, etc., of personal information is/are executed. Additionally, in a case of a rental car and/or a shared car, it is incorporated into an application that executes reservation, rental, etc., of a rental car and/or a shared car, so that it is preferably activated by a user before use of a vehicle.

In a case where a request for registration at step S22 in FIG. 10 is received from an on-vehicle device 10, the user device 30 (a control unit 34) displays an application screen that inquires availability of registration of personal information as illustrated in FIG. 11.

Then, as a user selects “Yes” and taps a “Send” button on such an application screen, the user device 30 executes step S23 in FIG. 10 (extraction from a personal information data storage unit 33b) and step S24 (transmission of extracted personal information data to the on-vehicle device 10). On the other hand, as a user selects “No” and taps a “Send” button, the user device 30 cancels a request for registration without executing step S23, S24 in FIG. 10. Additionally, in such a case, it is preferable that the user device 30 transmits information of cancelling of a request for registration to the on-vehicle device 10 and the on-vehicle device 10 executes notification (display, etc.) for such cancelling of a request for registration. Thereby, it is possible for a user to freely select whether or not his/her own personal information data are registered in a vehicle (the on-vehicle device 10) at a time of a start of use of such a vehicle.

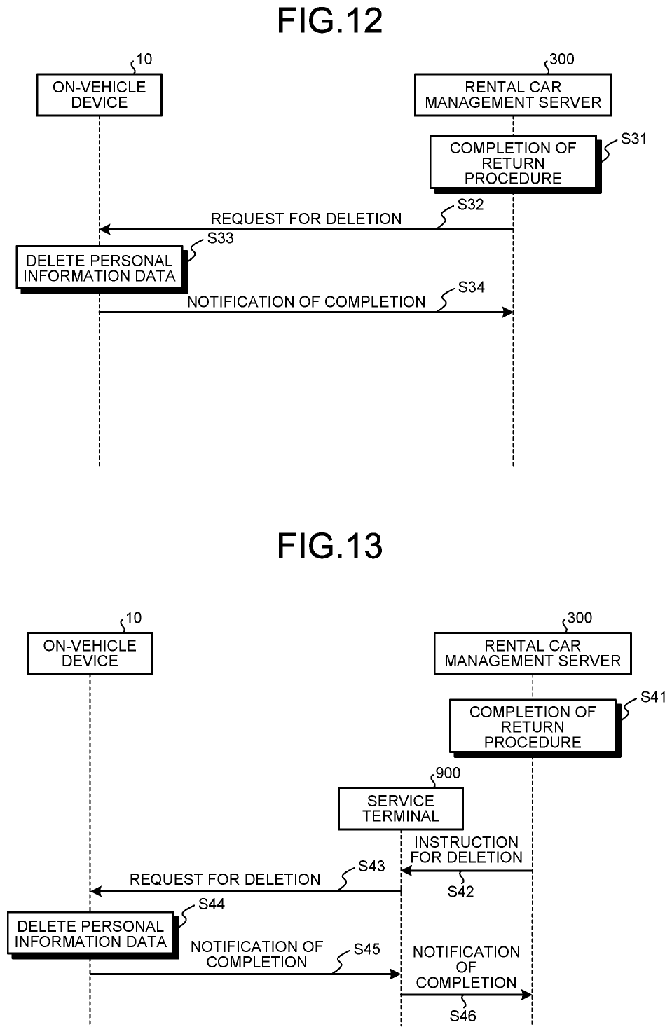

Next, process sequences of some variations of a deletion process will be explained. FIG. 12 is a diagram that illustrates a process sequence for an on-vehicle device 10 and a rental car management server 300 in a deletion process according to a first variation. Furthermore, FIG. 13 is a diagram that illustrates a process sequence for an on-vehicle device 10, a rental car management server 300, and a service terminal 900 in a deletion process according to a second variation.

A first variation and a second variation are examples where a timing of deletion is completion of a return procedure for a rental car. A second variation is different from a first variation in that the service terminal 900 is interposed therebetween.

As illustrated in FIG. 12, as a return procedure for a rental car is completed in the rental car management server 300 (step S31), a staff of a rental car sales office as an example operates a terminal that is connected to the rental car management server 300 so as to execute an operation of completion of such a return procedure for a rental car. Then, the rental car management server 300 (a control unit of the rental car management server 300) transmits a request for deletion of personal information to the on-vehicle device 10 of a returned rental car through a network N (step S32).

The on-vehicle device 10 (a control unit 18) receives a request for deletion from the rental car management server 300 and deletes personal information data that are stored in a personal information data storage unit 17b (step S33). Additionally, as described above, a timing of deletion of various types of data in personal information data is determined based on personal information control information that is stored in a personal information control information storage unit 17c as illustrated in FIG. 5. Then, the on-vehicle device 10 transmits notification of completion to the rental car management server 300 (step S34).

Alternatively, as illustrated in FIG. 13, as a return procedure for a rental car is completed (step S41), the rental car management server 300 transmits an instruction for deletion of personal information data for a returned rental car to the service terminal 900 through the network N (step S42). Additionally, such an instruction for deletion includes data for identifying a rental car that is a target for deleting personal information data and communication connection date for executing communication connection (a terminal address, etc.).

The service terminal 900 receives it and transmits a request for deletion of personal information data to the on-vehicle device 10 of a returned rental car thorough the network N or near field wireless communication (step S43).

The on-vehicle device 10 receives such a request for deletion and deletes personal information data that are stored in the personal information data storage unit 17b (step S44). Additionally, as described above, a timing of deletion of various types of data in personal information data is determined based on personal information control information that is stored in the personal information control information storage unit 17c as illustrated in FIG. 5. Then, the on-vehicle device 10 transmits notification of completion of deletion of personal information data to the service terminal 900 (step S45). Then, the service terminal 900 transmits (transfers) notification of completion of deletion of personal information data to the rental car management server 300 (step S46).

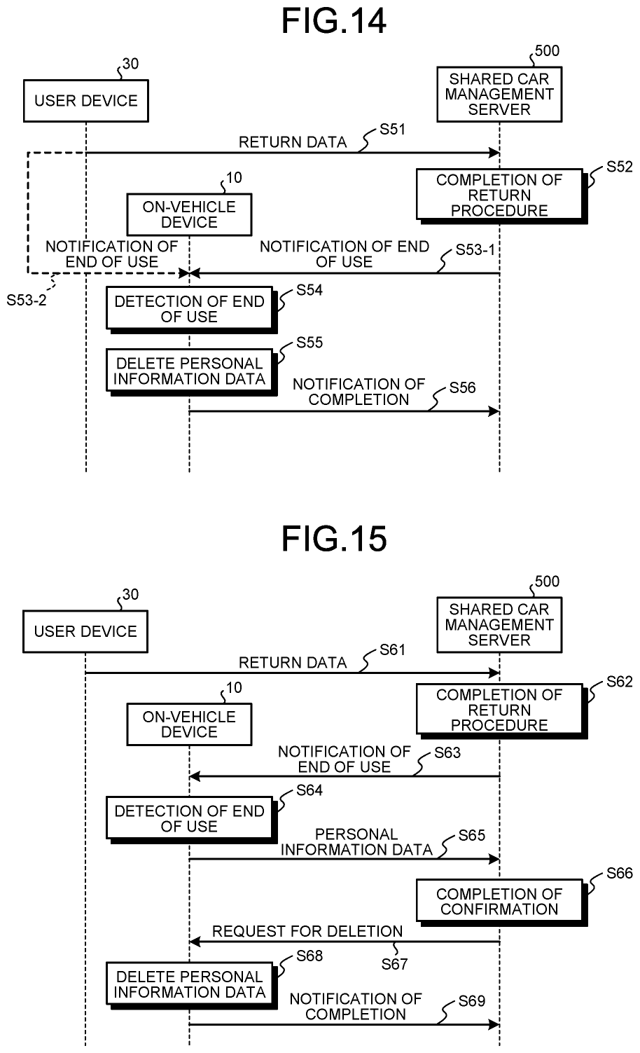

Subsequently, a third variation and a fourth variation that are adapted to a shared car will be explained. FIG. 14 is a diagram that illustrates a process sequence for a user device 30, an on-vehicle device 10, and a shared car management server 500 in a deletion process according to a third variation. Furthermore, FIG. 15 is a diagram that illustrates a process sequence for an on-vehicle device 10 and a shared car management server 500 in a deletion process according to a fourth variation.

A third variation and a fourth variation are examples where a timing of deletion is completion of a return procedure for a shared car. A fourth variation is different from a third variation in that personal information data that are left in the on-vehicle device 10 are confirmed on a side of the shared car management server 500.

As illustrated in FIG. 14, the user device 30 (a control unit 34) notifies the shared car management server 500 of a return data that are based on a return operation in a case where such a return operation is executed by a user (step S51). The shared car management server 500 (a control unit of the shared car management server 500) completes a return procedure based on a received return data from the user device 30 (step S52), and transmits notification of an end of use to the on-vehicle device 10 (step S53-1).

The on-vehicle device 10 receives notification of an end of use so as to detect an end of use of a shared car (step S54) and executes a use end process such as a process that prevents a shared car from being used (run). Then, the on-vehicle device 10 deletes personal information data that are stored in a personal information data storage unit 17b (step S55), and transmits notification of completion of a return process for a shared car to the shared car management server 500 (step S56).

Additionally, as described above, a timing of deletion of various types of data in personal information data is determined based on personal information control information that is stored in a personal information control information storage unit 17c as illustrated in FIG. 5.

Furthermore, transmission of notification of an end of use from the user device 30 to the on-vehicle device 10 (step S53-2) may be executed instead of transmission of notification of an end of use from the shared car management server 500 to the on-vehicle device 10 (step S53-1).

In a fourth variation, as illustrated in FIG. 15, the user device 30 (a control unit 34) notifies the shared car management server 500 of return data that are based on a return operation in a case where such a return operation is executed by a user (step S61). The shared car management server 500 (a control unit of the shared car management server 500) completes a return procedure based on received return data from the user device 30 (step S62) and transmits notification of an end of use to the on-vehicle device 10 (step S63).

The on-vehicle device 10 receives notification of an end of use so as to detect an end of use of a shared car (step S64) and executes a use end process such as a process that prevents a shared car from being used (run). Then, the on-vehicle device 10 transmits personal information data that are stored in the personal information data storage unit 17b to the shared car management server 500 (step S65). The shared car management server 500 displays received personal information data on a display, etc., for a shared car manager, etc., and acquires an input of a result of confirmation that is executed by such a shared car manager. That is, a shared car manager views a recorded video, etc., in dashboard-camera-related personal information in personal information data so as to determine presence or absence of occurrence of an accident, etc., unauthorized use, etc., and executes an operational input of a result thereof to the shared car management server 500.

Then, if the shared car management server 500 completes confirmation of a normal end of use of a shared car based on an operational input, etc., that is/are executed by a shared car manager (step S66), it transmits a request for deletion of personal information data to the on-vehicle device 10 (step S67). As the on-vehicle device receives a request for deletion from the shared car management server 500, it deletes personal information data that are stored in the personal information data storage unit 17b (step S68) and transmits notification of completion of a return process for a shared car to the shared car management server 500 (step S69).

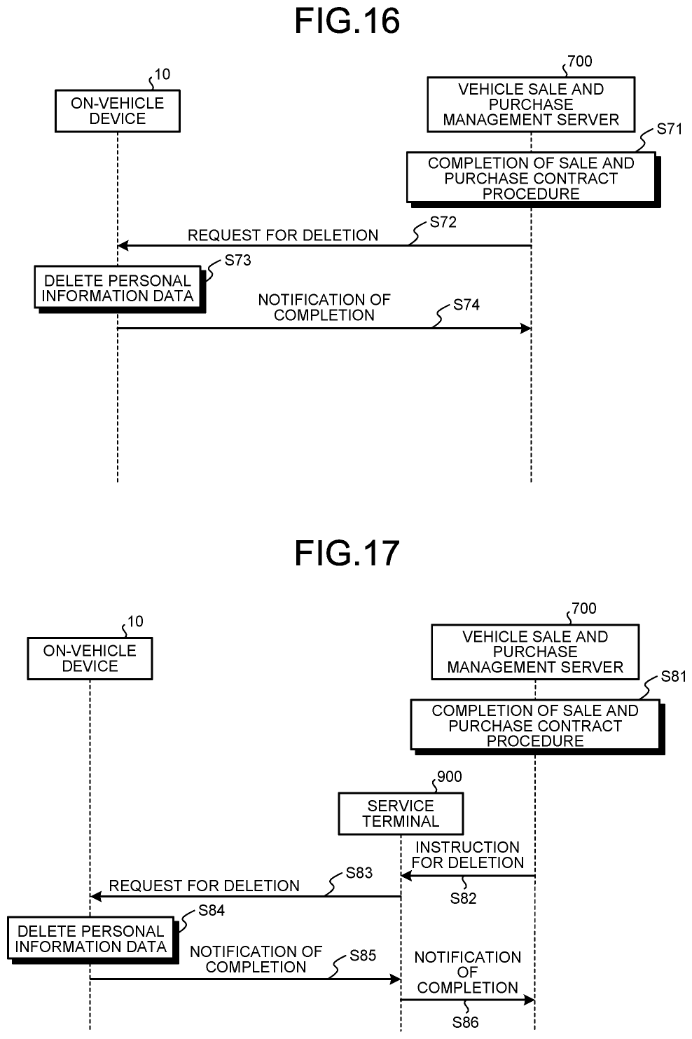

Next, a fifth variation and a sixth variation that are adapted to sale and purchase of a vehicle will be explained. FIG. 16 is a diagram that illustrates a process sequence for an on-vehicle device 10 and a vehicle sale and purchase management server 700 in a deletion process according to a fifth variation. Furthermore, FIG. 17 is a diagram that illustrates a process sequence for an on-vehicle device 10, a vehicle sale and purchase management server 700, and a service terminal 900 in a deletion process according to a sixth variation.

A fifth variation and a sixth variation are example where a timing of deletion is completion of a sale and purchase contract procedure for a vehicle. A sixth variation is different from a fifth variation in that the service terminal 900 is interposed therebetween.

As illustrated in FIG. 16, as a sale and purchase contract procedure for a vehicle is completed in the vehicle sale and purchase management server 700 (step S71), for example, a staff of a vehicle purchase business operator operates a terminal that is connected to the vehicle sale and purchase management server 700 so as to execute an operation of completion of a sale and purchase contract procedure. Then, the vehicle sale and purchase management server 700 (a control unit of the vehicle sale and purchase management server 700) transmits a request for deletion of personal information to the on-vehicle device of a vehicle that is a sale and purchase target through a network N (step S72).

The on-vehicle device 10 (a control unit 18) receives a request for deletion from the vehicle sale and purchase management server 700 and deletes personal information data that are stored in a personal information data storage unit 17b (step S73). Additionally, as described above, a timing of deletion of various types of data in personal information data is determined based on personal information control information that is stored in a personal information control information storage unit 17c as illustrated in FIG. 5. Then, the on-vehicle device 10 transmits notification of completion of deletion of personal information data to the vehicle sale and purchase management server 700 (step S74).

Alternatively, as illustrated in FIG. 17, as a sale and purchase contract procedure for a vehicle is completed (step S81), the vehicle sale and purchase management server 700 transmits an instruction for deletion of personal information data for a vehicle that is a sale and purchase target to the service terminal 900 through the network N (step S82). Additionally, such an instruction for deletion includes data for identifying a vehicle that is a target for deletion of personal information data and communication connection data for executing communication connection (a terminal address, etc.).

The service terminal 900 receives it and transmits a request for deletion of personal information data to the on-vehicle device 10 of a vehicle that is a sale and purchase target, through the network N or near field wireless communication, etc. (step S83).

The on-vehicle device 10 receives such a request for deletion and deletes personal information data that are stored in the personal information data storage unit 17b (step S84). Additionally, as described above, a timing of deletion of various types of data in personal information data is determined based on personal information control information that is stored in the personal information control information storage unit 17c as illustrated in FIG. Then, the on-vehicle device 10 transmits notification of completion of deletion of personal information data to the service terminal 900 (step S85). Then, the service terminal 900 transmits (transfers) notification of completion of deletion of such personal information data to the vehicle sale and purchase management server 700 (step S86).

Additionally, each of the rental car management server 300, the shared car management server 500, and the vehicle sale and purchase management server 700 that are explained by using FIG. 12 to FIG. 17 corresponds to an example of a “vehicle management device” as already described where basic configurations thereof are similar and a program that realizes a function corresponds to a process of a function as described above. Next, a configuration example of such a vehicle management device will be explained.

FIG. 18 is a block diagram that illustrates a configuration example of a vehicle management device 1100 according to an embodiment. As illustrated in FIG. 18, the vehicle management device 1100 according to an embodiment has a communication unit 1101, a storage unit 1102, and a control unit 1103.

The communication unit 1101 is realized by a network adapter, etc. The communication unit 1101 is connected to a network N by wire or wirelessly and executes transmission/receipt of information to/from an on-vehicle device 10, a user device 30, and a service terminal 900 through the network N.

The storage unit 1102 is realized by a storage device such as a RAM, a flash memory, a hard disk, and/or an optical disk and stores various types of information.

The control unit 1103 is a controller that is similar to a control unit 18, a control unit 34, and a control unit 103 as described above, is composed of a CPU, an MPU, etc., and is realized by such a CPU, an MPU, etc., that execute(s) various types of programs that are stored in the storage unit 1102 while an RAM is provided as a working area. Furthermore, it is possible to realize the control unit 1103 by an integrated circuit such as an ASIC and/or an FPGA.

The control unit 1103 has an acquisition unit 1103a and a response processing unit 1103b and realizes or executes a function and/or an action of information processing as explained below.

The acquisition unit 1103a acquires various types of information from the on-vehicle device 10, the user device 30, and the service terminal 900 as illustrated in FIG. 12 to FIG. 17, and input operation information that is provided by a user (a staff of a car rental business operator) of the vehicle management device 1100 through a communication unit 101. The response processing unit 1103b executes various types of processes as illustrated in FIG. 12 to FIG. 17 (transmission of an instruction for deletion of personal information data to the on-vehicle device 10, transmission of notification of an end of use of a shared car to the on-vehicle device 10, etc.), depending on various types of information that are acquired by the acquisition unit 1103a. For example, the control unit 1103 transmits vehicle use end information (notification of an end of use, etc.) that indicates an end of use of a vehicle to the on-vehicle device 10 in a case where an operation of a procedure that indicates an end of use of such a vehicle is detected. Furthermore, the control unit 1103 transmits vehicle use start information that indicates a start of use of a vehicle to the on-vehicle device 10 in a case where an operation of a procedure that indicates a start of use of such a vehicle is detected.

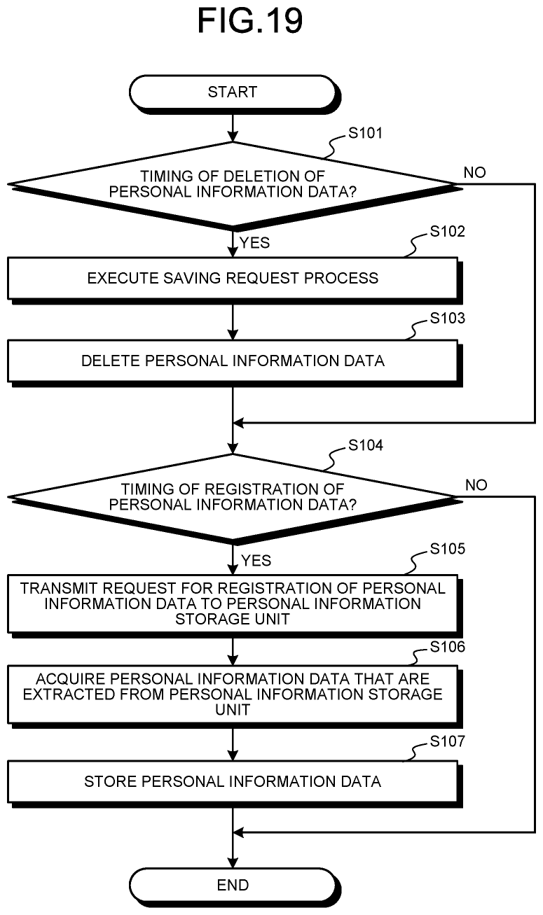

Next, process steps that are executed by the on-vehicle device 10 (a control unit 18) according to an embodiment will be explained by using FIG. 19. FIG. 19 is a flowchart that illustrates process steps that are executed by an on-vehicle device 10 according to an embodiment. Additionally, process steps in FIG. 19 are repeatedly executed during an operation of the on-vehicle device 10.

As illustrated in FIG. 19, the control unit 18 of the on-vehicle device 10 determines whether or not a timing of deletion of personal information data is provided based on personal information control information as illustrated in FIG. 5, a vehicle state, a state of a rental procedure, etc. (step S101). In a case where a timing of deletion of personal information data is provided (step S101, Yes), the control unit 18 executes a saving request process (step S102). That is, the control unit 18 transmits a request for saving of personal information data that are stored in a storage unit 17 to a personal information storage unit (a personal information management server 100 or a user device so as to save such personal information data. Then, the control unit 18 deletes personal information data that are stored in the storage unit 17 (step S103). In a case where a timing of deletion of personal information data is not provided (step S101, No), transition to step S104 is executed.

Furthermore, the control unit 18 determines whether or not a timing of registration of personal information data is provided based on personal information control information as illustrated in FIG. 5, a vehicle state, a state of a rental procedure, etc. (step S104). In a case where a timing of registration of personal information data is provided (step S104, Yes), the control unit 18 transmits a request for registration of personal information data to a personal information storage unit (the personal information management server 100 or the user device 30) (step S105) and causes such a personal information storage unit to extract corresponding personal information data. Then, the control unit 18 acquires personal information data that are extracted from a personal information storage unit (step S106).

Then, the control unit 18 stores acquired personal information data in a personal information data storage unit 17b (step S107) and ends such a process. Furthermore, in a case where a timing of registration of personal information data is not provided (step S104, No), the control unit 18 ends such a process.

As has been described above, an on-vehicle device according to an embodiment (that corresponds to an example of an “information processing device”) is an information processing device that executes storage control for personal information data that are stored in a storage unit 17 in an on-vehicle device 10 that executes an operation that is based on such personal information data that are stored in the storage unit 17, and has a control unit 18 (that corresponds to an example of a “controller”). The control unit 18 executes, in a case where an end of use of a vehicle is detected, a deletion process that deletes personal information data that are stored in the storage unit 17, and executes, in a case where a start of use of a vehicle is detected, a registration process that stores, in the storage unit 17, personal information data of a user for the on-vehicle device 10 that are acquired from an external device.

Therefore, for an on-vehicle device 10 according to an embodiment, it is possible to protect personal information appropriately.

Furthermore, the control unit 18 executes, in a case where the end of use is detected, a saving request process that transmits and stores personal information data that are stored in the storage unit 17 to/in the external device, prior to the deletion process.

Therefore, for an on-vehicle device 10 according to an embodiment, it is possible to save personal information data that are stored in a storage unit 17 into an external device, prior to the deletion process.

Furthermore, the control unit 18 detects the end of use and the start of use based on a condition that is dependent on a type of usage of a vehicle.

Therefore, for an on-vehicle device 10 according to an embodiment, a timing of deletion and a timing of registration that are dependent on a type of usage of a vehicle are detected and the deletion process and the registration process that are based on such timings are executed, so that it is possible to protect personal information appropriately depending on such a type of usage of a vehicle.

Furthermore, the control unit 18 detects, in a case where a vehicle is a rental car or a shared car, the end of use, based on return procedure completion information from a management system for a rental car or a shared car.

Therefore, for an on-vehicle device 10 according to an embodiment, in a case where a vehicle is a rental car or a shared car, it is possible to execute the deletion process where a timing of deletion is a time of completion of a return procedure, depending on a type of usage that is a rental car or a shared car.

Furthermore, the control unit 18 detects, in a case where a vehicle is a transport vehicle, the end of use, based on confirmation completion information for personal information data from a management system for a transport vehicle.

Therefore, for an on-vehicle device 10 according to an embodiment, in a case where a vehicle is a transport vehicle, it is possible to execute the deletion process where a timing of deletion is a time of completion of confirmation of a driving situation of a driver that is important for management of an operation and is executed by a manager, etc., of a transport business operator, depending on a type of usage that is a transport vehicle.

Furthermore, the control unit 18 detects, in a case where a vehicle is a rental car or a shared car, the start of use, based on rental procedure completion information from a management system for a rental car or a shared car.

Therefore, for an on-vehicle device 10 according to an embodiment, in a case where a vehicle is a rental car or a shared car, it is possible to execute the registration process where a timing of registration is a time of completion of a rental procedure, depending on a type of usage that is a rental car or a shared car.

Furthermore, the control unit 18 detects approaching of a user for a vehicle to such a vehicle as the start of use.

Therefore, for an on-vehicle device 10 according to an embodiment, it is possible to execute the registration process conveniently where a timing of registration is approaching of a user for a vehicle to such a vehicle.

Furthermore, the external device is a user device 30 that is carried by a user for a vehicle or a personal information management server 100 that manages personal information data.

Therefore, for an on-vehicle device 10 according to an embodiment, it is possible to protect personal information appropriately where a user device 30 or a personal information management server 100 is provided as a personal information storage unit, for example, a backup device.

Furthermore, a user device 30 according to an embodiment is a mobile terminal device that communicates with an on-vehicle device 10 and has a storage unit 33 (that corresponds to an example of a “terminal storage unit”) that stores personal information data and a control unit 34 (that corresponds to an example of a “terminal controller”). The control unit 34 transmits personal information data that are stored in the storage unit 33 to the on-vehicle device 10, based on a request for acquisition of personal information data from the on-vehicle device 10, and stores, in a case where personal information data that correspond to a user for the user device 30 are provided, personal information data that are transmitted from the on-vehicle device 10 in the storage unit 33, based on a request for saving of personal information data from the on-vehicle device 10.

Therefore, for a user device 30 according to an embodiment, it is possible to protect personal information conveniently and appropriately where such a user device 30 is provided as a personal information storage unit, for example, a backup device.

Furthermore, a vehicle management device 1100 according to an embodiment is a vehicle management device that communicates with an on-vehicle device 10 and manages a vehicle, and has a control unit 1103 (that corresponds to an example of a “device controller”). The control unit 1103 transmits, in a case where an operation of a procedure that indicates the end of use is detected, vehicle use end information that indicates the end of use to the on-vehicle device 10, and transmits, in a case where an operation of a procedure that indicates the start of use is detected, vehicle use start information that indicates the start of use to the on-vehicle device 10.

Therefore, for a vehicle management device 1100 according to an embodiment, it is possible to cause an on-vehicle device 10 to execute the deletion process in a case where an operation of a procedure that indicates the end of use is detected, and cause the on-vehicle device 10 to execute the registration process in a case where an operation of a procedure that indicates the start of use is detected.

Furthermore, an on-vehicle device 10 according to an embodiment is an on-vehicle device that is mounted on a vehicle and executes control of an operation that is based on personal information data that are stored in a storage unit 17, and has a control unit 18. The control unit 18 executes a deletion process that deletes personal information data that are stored in the storage unit 17, in a case where an end of use of a vehicle is detected, and executes a registration process that stores, in the storage unit 17, personal information data of a user for the on-vehicle device 10 that are acquired from an external device, in a case where a start of use of a vehicle is detected.

Therefore, for an on-vehicle device 10 according to an embodiment, it is possible to protect personal information appropriately.

Furthermore, a personal information protection system 1 according to an embodiment (that corresponds to an example of a “vehicle management system”) includes an on-vehicle device 10 that is mounted on a vehicle, executes an operation that is based on personal information data that are stored in a storage unit 17, and executes storage control for personal information data that are stored in the storage unit 17, a personal information management server 100 (that corresponds to an example of a “personal information management device”) that is set outside a vehicle and executes management of personal information data, and a vehicle management device 1100 that executes management of a vehicle. The on-vehicle device 10 executes, in a case where an end of use of a vehicle is detected based on vehicle use end information from the vehicle management device 1100, a saving request process that transmits and stores personal information data that are stored in the storage unit 17 to/in the personal information management server 100, and a deletion process that deletes personal information data that are stored in the storage unit 17. Furthermore, the on-vehicle device 10 executes, in a case where a start of use of a vehicle is detected based on vehicle use start information from the vehicle management device 1100, a request for acquisition of personal information data from an external device, and executes a registration process that stores, in the storage unit 17, personal information data of a user for the on-vehicle device 10 that are acquired from the external device by such a request for acquisition. The personal information management server 100 transmits personal information data that are stored in a storage unit 102 (that corresponds to an example of a “device storage unit”) to an on-vehicle device, based on a request for acquisition of personal information data from the on-vehicle device 10. Furthermore, the personal information management server 100 stores personal information data that are transmitted from the on-vehicle device 10 in the storage unit 102, based on a request for saving of personal information data from the on-vehicle device 10. The vehicle management device 1100 transmits the vehicle use end information that indicates the end of use to the on-vehicle device 10, in a case where an operation of a procedure that indicates the end of use is detected, and transmits the vehicle use start information that indicates the start of use to the on-vehicle device 10, in a case where an operation of a procedure that indicates the start of use is detected.

Therefore, for a personal information protection system 1 according to an embodiment, it is possible to protect personal information appropriately.

Furthermore, a personal information protection method according to an embodiment (that corresponds to an example of a “personal information processing method”) is a personal information processing method that executes storage control for personal information data that are stored in a storage unit 17 in an on-vehicle device 10 that executes an operation that is based on personal information data that are stored in the storage unit 17, where, in a case where an end of use of a vehicle is detected, personal information data that are stored in the storage unit 17 are stored in an external device and personal information data that are stored in the storage unit 17 are deleted, and in a case where a start of use of a vehicle is detected, personal information data of a user for the on-vehicle device 10 that are acquired from the external device are stored in the storage unit 17.

Therefore, for a personal information protection method according to an embodiment, it is possible to protect personal information appropriately.

According to an aspect of an embodiment, it is possible to protect personal information appropriately.

It is possible for a person(s) skilled in the art to readily derive an additional effect(s) and/or variation(s). Hence, a broader aspect(s) of the present invention is/are not limited to a specific detail(s) and a representative embodiment(s) as illustrated and described above. Therefore, various modifications are possible without departing from the spirit or scope of a general inventive concept that is defined by the appended claim(s) and an equivalent(s) thereof.

What is claimed is:

1. An information processing device that executes storage control for personal information data that are stored in a storage unit in an on-vehicle device that executes an operation that is based on personal information data that are stored in the storage unit, and comprises a controller, wherein the controller:
executes a deletion process that deletes personal information data that are stored in the storage unit, in a case where an end of use of a vehicle is detected; and
executes a registration process that stores, in the storage unit, personal information data of a user for the on-vehicle device that are acquired from an external device, in a case where a start of use of a vehicle is detected.

2. The information processing device according to claim 1, wherein
the controller executes a saving request process that transmits and stores personal information data that are stored in the storage unit to/in the external device, prior to the deletion process, in a case where the end of use is detected.

3. The information processing device according to claim 1, wherein
the controller detects the end of use and the start of use based on a condition that is dependent on a type of usage of a vehicle.

4. The information processing device according to claim 2, wherein
the controller detects the end of use and the start of use based on a condition that is dependent on a type of usage of a vehicle.

5. The information processing device according to claim 3, wherein
the controller detects the end of use based on return procedure completion information from a management system for a rental car or a shared car in a case where a vehicle is a rental car or a shared car.

6. The information processing device according to claim 3, wherein
the controller detects the end of use based on confirmation completion information for personal information data from a management system for a transport vehicle in a case where a vehicle is a transport vehicle.

7. The information processing device according to claim 3, wherein
the controller detects the start of use based on rental procedure completion information from a management system for a rental car or a shared car in a case where a vehicle is a rental car or a shared car.

8. The information processing device according to claim 3, wherein
the controller detects approaching of a user for a vehicle to a vehicle as the start of use.

9. The information processing device according to claim 1, wherein
the external device is a user device that is carried by a user for a vehicle or a personal information management server that manages personal information data.

10. The information processing device according to claim 2, wherein
the external device is a user device that is carried by a user for a vehicle or a personal information management server that manages personal information data.

11. A mobile terminal device that communicates with the information processing device according to claim 1, and comprises:
a terminal storage unit that stores personal information data; and
a terminal controller,
wherein the terminal controller
transmits personal information data that are stored in the terminal storage unit to the information processing device, based on a request for acquisition of personal information data from the information processing device, and
stores, in the terminal storage unit, personal information data that are transmitted from the information processing device, based on a request for saving of personal information data from the information processing device, in a case where personal information data that correspond to a user for the mobile terminal device are provided.

12. A vehicle management device that communicates with the information processing device according to claim 1, manages a vehicle, and comprises a device controller,
wherein the device controller:
transmits vehicle use end information that indicates the end of use to the information processing device, in a case where an operation of a procedure that indicates the end of use is detected; and
transmits vehicle use start information that indicates the start of use to the information processing device, in a case where an operation of a procedure that indicates the start of use is detected.

13. An on-vehicle device that is mounted on a vehicle, executes control of an operation that is based on personal information data that are stored in a storage unit, and comprises a controller,
wherein the controller:
executes a deletion process that deletes personal information data that are stored in the storage unit, in a case where an end of use of a vehicle is detected; and
executes a registration process that stores, in the storage unit, personal information data of a user for the on-vehicle device that are acquired from an external device, in a case where a start of use of a vehicle is detected.

14. The on-vehicle device according to claim 13, wherein
the controller executes a saving request process that transmits and stores personal information data that are stored in the storage unit to/in the external device, prior to the deletion process, in a case where the end of use is detected.

15. A personal information processing method that executes storage control for personal information data that are stored in a storage unit in an on-vehicle device that executes an operation that is based on personal information data that are stored in the storage unit, wherein:
in a case where an end of use of a vehicle is detected, personal information data that are stored in the storage unit are deleted; and
in a case where a start of use of a vehicle is detected, personal information data of a user for the on-vehicle device that are acquired from an external device are stored in the storage unit.

16. The personal information processing method according to claim 15, wherein
in a case where the end of use is detected, personal information data that are stored in the storage unit are stored in the external device, before personal information data that are stored in the storage unit are deleted.
